(19) United States
(12) Patent Application Publication
(10) Pub. No.: US 2012/0014764 A1
(43) Pub. Date: Jan. 19, 2012

(54) CONTAMINANT-REJECTING SCREW THREADS

(76) Inventors: Glen W. Davidson, Roseville, MN (US); Chad R. Taszarek, Albertville, MN (US)

(21) Appl. No.: 13/258,555

(22) PCT Filed: Mar. 24, 2010
(86) PCT No.: PCT/US10/28426

§ 371 Date: Sep. 22, 2011

Related U.S. Application Data
(60) Provisional application No. 61/163,582, filed on Mar. 26, 2009.

(51) Int. Cl. F16B 33/06

(52) U.S. Cl. 411/411; 411/437

(57) ABSTRACT

A threaded connection (10) has an improved ability to engage and tighten screw threads (16) when they are contaminated with gritty materials. Adding axial grooves (18) to the male (14) and/or female (12) halves of a screw thread (16) enables the tightening action to expel gritty contaminants from the mesh of the threads by providing an “escape path” for the contaminants.

### TECHNICAL FIELD

This application claims the benefit of U.S. application Ser. No. 61/163,582, filed Mar. 26, 2009, the contents of which are hereby incorporated by reference.

### BACKGROUND ART

### Disclosure of the Invention

The instant invention improves the ability to engage and tighten screw threads when they are contaminated with gritty materials.

Adding axial grooves to the male and/or female halves of a screw thread enables the tightening action to expel gritty contaminants from the mesh of the threads by providing an “escape path” for the contaminants. In traditional threads, when the grit is smaller than the thread clearances, and/or the grit is much larger than the clearances, the tightening action sometimes expels the contaminants continuously as tightening occurs. But when the grit size is comparable to thread clearances, the grit may jam in the mesh, preventing further tightening. Utilizing the instant invention, however, repeated partial loosening then tightening the parts moves the contaminants into the axial grooves, and/or crushes the contaminants, allowing the thread to be fully tightened. The grooves are effective if placed in either the male or the female part, with some additional improvement seen if they are present in both the male & female parts. The grooves should be radially at least as deep as the minor diameter of the male part, or the major diameter of the female part, with additional improvement seen when the grooves are radially deeper than that. And adding radial escape ports connected to those grooves can provide an even shorter path and more effective rejection of the grit.

These grooves can increase the chance for thread misalignment when the parts are first brought together (“crossthreading”), but adding “pilot diameters” (removed threads at the beginning of the mesh) essentially eliminates crossthreading.

Without the grooves some combinations of threads and gritty contaminants become impossible to tighten without excessive effort and/or damage to the parts. Addition of the grooves allows the majority of those combinations to be securely tightened, especially if the incremental loosen-then-tighten procedure is used.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 is a view of the female portion of a threaded connection utilizing the instant invention.

FIG. 2 is a cross-section of a threaded connection utilizing the instant invention.

FIG. 3 is a cross-section of the female portion of a threaded connection

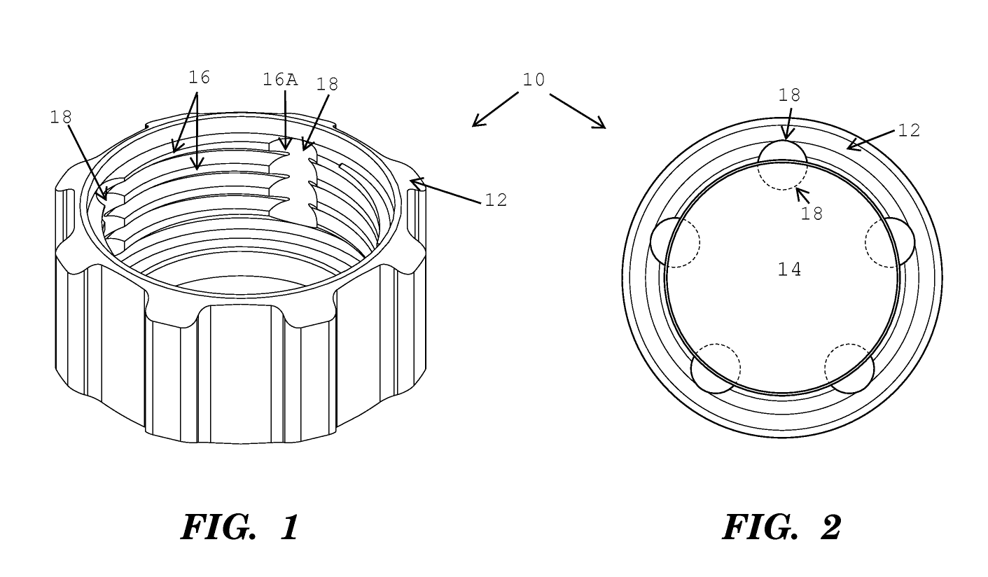

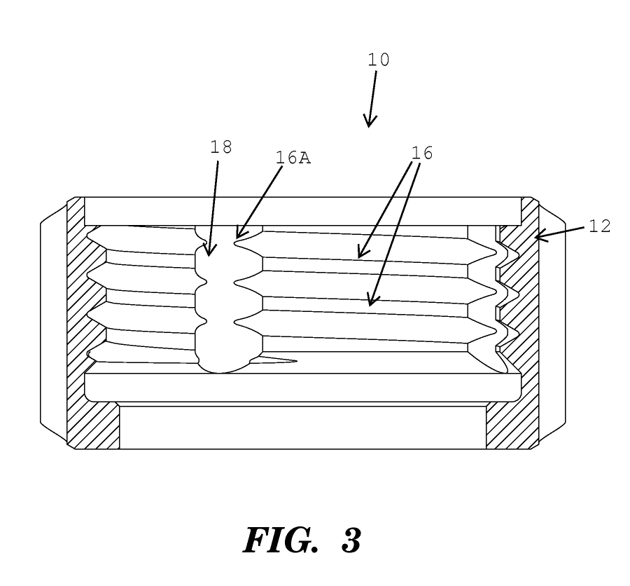

### BEST MODE FOR CARRYING OUT THE INVENTION

The instant invention, generally designated 10, is a threaded connection comprised of female 12 and male 14 portions. The threads 16 may be of any known size or geometry. One of more grooves 18 may provided that extend axially along the longitudinal axis (or axis of rotation) of the threaded connection. In the preferred embodiment, grooves 18 are provided in the female portion 12 of the connection but the grooves 18 may also be located in the male portion 14 (as shown in FIG. 2) or in both portions.

Also in the preferred embodiment, grooves 18 extend deeper (radially farther for the female portion 12) than the bottom or root 16a of threads 16 on female portion 12. This provides a path for contaminants to be pushed into.

It is contemplated that various changes and modifications may be made to the threaded connection without departing from the spirit and scope of the invention as defined by the following claims.

1. In a threaded connection having male and female portions and a longitudinal axis, each portion having complementary threads thereon, the improvement comprising at least one axially extending groove extending through said threads on at least one of said portions.

2. The threaded connection of claim 1 wherein said groove has a depth and said threads have a depth and a root, wherein said groove depth is greater than said thread depth.

3. The threaded connection of claim 1 wherein said groove is located on said female portion.

4. The threaded connection of claim 1 wherein at least one said groove is located on said male portion.

5. The threaded connection of claim 1 wherein at least one said groove is located on said female portion.

6. The threaded connection of claim 1 wherein at least one said groove is located on each of said portions.
